(19) United States
(12) Patent Application Publication
(10) Pub. No.: US 2010/0175036 A1
(43) Pub. Date: Jul. 8, 2010

(54) LOGIC CIRCUIT MODEL VERIFYING METHOD AND APPARATUS

(75) Inventor: Tsuyoshi Mochizuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/725,709

(22) Filed: Mar. 17, 2010

Related U.S. Application Data
(63) Continuation of application No. PCT/JP2007/070326, filed on Oct. 18, 2007.

(51) Int. Cl. G06F 17/50

(52) U.S. Cl. 716/5

(57) ABSTRACT

To a logic circuit model, a test pattern by a combination of a first logical value A representing 0 or 1 and a second logical value B representing 1 or 0 as an inverse value corresponding to the first logical value A is given to calculate an output of the logic circuit model with a logical operation and, when the output is compared with an expected value for the test pattern and they are equal to each other, it is determined that the operation of the logic circuit model is correct. With the second logical value B representing 1 when the first logical value represents 0 and the second logical value B representing 0 when the first logical value A represents 1, a logical operation of the logic circuit model is performed.

This application is a continuation of PCT/JP2007/062669 filed Jun. 26, 2007.

### FIELD

Embodiments discusses herein relate to logic circuit model verifying methods and operation verifying apparatuses for use in designing semiconductor devices.

### BACKGROUND

Conventionally, in a computer-supported operation of designing a large-scale integrated circuit, the process procedure goes from system designing, function designing, logic designing, and then layout designing, thereby finally generating mask data. Among these, in logic designing, a gate level logic circuit (net list) is generate by using a logic combining tool from a logic circuit of an Register Transfer Level (RTL) generated in function designing, and the operation is checked by a logic simulator. Such a logic simulator normally performs an event-driven-scheme simulation. In the event-driven-scheme simulation, attention is given to an element (primitive), such as a logic gate, with a change (event) of a signal, and only an element at the next stage of the element where the event has occurred is calculated based on a true-value table and, when the output from the element is changed, the change of the signal is transferred to the next stages in sequence to verify whether an expected value set to the target element can be obtained. States used by a conventional logic simulator are normally quarternary values, that is, 0, 1, X, and Z. Here, X is undefined and Z represents a high impedance. When these quarternary-value states are used to perform path connection verification, value propagation check, or the like, a value is set to a pin serving as a driver and a simulation is performed a plurality of times for verification.

### First Patent Document: Japanese Unexamined Patent Application Publication No. 06-314185

However, in this conventional logic simulator, for example, when a one-to-N activation check for a path is performed, 0 or 1 is scheduled to a pin serving as a driver to check to see whether an expected value has been arrived at a check-target pin serving as a receiver. Therefore, to perform an activation test for a certain path, it is required to prepare two expected values of 0 and 1 and perform a simulation twice. Moreover, in normal quarternary-value states, it is extremely difficult to verify whether the value at the propagation source has really arrived at the propagation destination. Also, when a through check and verification (a through check) of a path is performed, even if 0 or 1 is scheduled to the pin serving as a driver, the propagation state may become X according to a logic from another path. Moreover, as the circuit is more complex, it is extremely more difficult to determine whether the value from the pin serving as the driver has arrived, and verification disadvantageously takes more time and efforts.

### SUMMARY

According to aspects of the present invention, a logic circuit model verifying method for verifying an operation of the logic circuit model including:

giving the logic circuit model a test pattern which is a combination of a first logical value A representing one of 0 or 1, and a second logical value B representing the other of 1 or 0 as an inverted value of the first logical value A;

performing a logic operation of the logic circuit model based on the given test pattern and calculating the output value of the logic circuit model;

comparing the output value of the logic circuit model and an expected value which is a value the logic circuit model is expected to output when performing the logic operation based on the given test pattern; and

determining, when the output value of the logic circuit model and the expected value are equal to each other, that the operation of the logic circuit model is correct.

### BRIEF DESCRIPTION OF THE DRAWINGS

FIG. 1 is an illustrative diagram depicting a circuit-design CAD system to which an embodiment is applied;

FIG. 2 is an illustrative diagram depicting details of an operation verifying unit of the present embodiment using an event-driven-scheme logic simulator provided to FIG. 1;

FIG. 3 is an illustrative diagram depicting definitions of added special states in the present embodiment;

FIG. 4 is an illustrative diagram depicting a program structure of a simulation executing unit of FIG. 2;

FIG. 5 is a block diagram depicting a hardware environment of a computer on which a program of the present embodiment is executed;

FIG. 6 is an illustrative diagram depicting a true-value table of a buffer in the present embodiment;

FIG. 7 is an illustrative diagram depicting a true-value table of an inverter in the present embodiment;

FIG. 8 is an illustrative diagram depicting a true-value table of a logical multiplication operation circuit (AND gate) in the present embodiment;

FIG. 9 is an illustrative diagram depicting a true-value table of a logical sum operation circuit (OR gate) in the present embodiment;

FIG. 10 is an illustrative diagram depicting a true-value table of an exclusive OR operation circuit (EOR gate) in the present embodiment;

FIG. 11 is an illustrative diagram depicting a true-value table of a dot operation circuit in the present embodiment;

FIG. 12 is a circuit diagram depicting an example of a single path subjected to activation verification;

FIGS. 13A and 13B are circuit diagrams depicting conventional activation verification of a single path using normal quarternary-value states;

FIG. 14 is a circuit diagram depicting activation verification of a single path using special states of the present embodiment;

FIG. 15 is a circuit diagram depicting activation verification of a plurality of paths using the special states of the present embodiment;

FIGS. 16A and 16B are circuit diagrams depicting through check and verification of a path using a special state of the present embodiment;

FIG. 17 is an illustrative diagram depicting simulation tables for use in the logic simulator of the present embodiment;

FIG. 18 is an illustrative diagram depicting a simulation table of a 2-input 1-output AND gate;

FIGS. 19A and 19B are illustrative diagrams depicting a schedule function in the logic simulator of the present embodiment;

FIG. 20A is an illustrative diagram each depicting a simulation executing function in the logic simulator of the present embodiment;

FIG. 20B is an illustrative diagram depicting the simulation executing function continued from FIG. 20A;

FIG. 20C is an illustrative diagram depicting the simulation executing function continued from FIG. 20B; and

FIG. 21 is a flowchart depicting a simulation executing process in the logic simulator of the present embodiment.

### DESCRIPTION OF EMBODIMENT

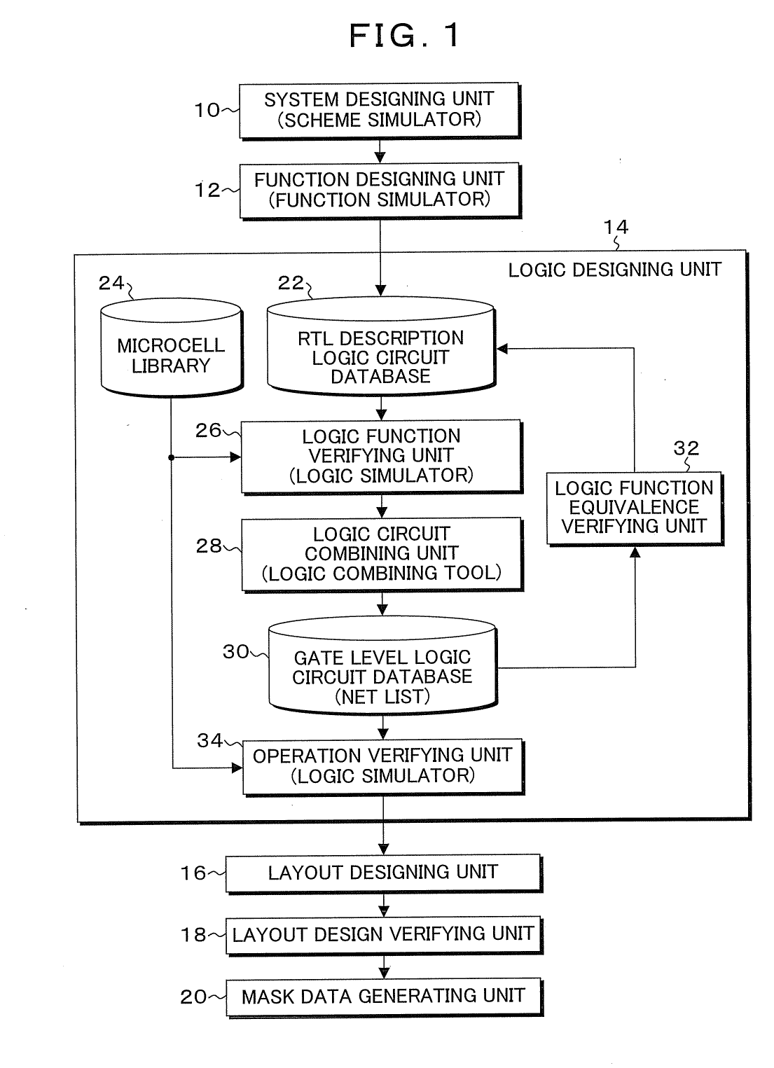

FIG. 1 is a illustrative diagram depicting a circuit designing CAD system to which a logic circuit model verifying method according to an embodiment is applied. In FIG. 1, the circuit designing CAD system includes a system designing unit 10, a function designing unit 12, a logic designing unit 14, a layout designing unit 16, a layout design verifying unit 18, and a mask data generating unit 20. The system designing unit 10 determines which functions of blocks the entire LSI as a design target is divided into and how to operate them, and a simulator called a scheme simulator is used. The function designing unit 12 performs a design for determining the structure and operation of the inside of the function blocks of the LSI at a RTL, and a function simulator is used for verifying the design result. The logic designing unit 14 designs a gate level logic circuit known as a net list and, for operation check, an event-driven-scheme logic simulator is used in the present embodiment. The layout designing unit 16 performs a process of converting a circuit diagram to an element layout and wiring with physical shapes and dimensions, and a layout and wiring program supporting automatic designing or the like is used. The layout design verifying unit 18 performs verification to check whether the designed layout has a design error, such as a design rule check (DRC) to check rule violation of the designed dimensions, a connection check to check a connection error, and an electric rule check on a circuit element, such as a transistor. The mask data generating unit 20 generates mask data with a mask data generating program from data subjected to layout design verification. The logic designing unit 14 of the present embodiment includes, in detail, an RTL description logic circuit database 22, a microcell library 24, a logic function verifying unit 26, a logic circuit combining unit 28, a gate level logic circuit database 30, a logic function equivalence verifying unit 32, and an operation verifying unit 34. In the RTL description logic circuit database 22, an RTL description logic circuit designed in the function designing unit 12 is stored and, for that circuit as a target, the logic function verifying unit 26 verifies a logic function by using the logic simulator. Subsequently, the logic circuit combining unit 28 obtained as a logic combining tool converts the RTL description logic circuit to a gate level logic circuit (net list) and stores it in the gate level logic circuit database 30. The gate level logic circuit of the gate level logic circuit database 30 is verified by the logic function equivalence verifying unit 32 and, if there is an error, the RTL description logic circuit database 22 reflects this error result. The operation verifying unit 34 according to the present embodiment performs verification to check the operation of a gate level logic circuit (logic circuit model) stored in the gate level logic circuit database 30 by using a test pattern and, in the present embodiment, an event-driven-scheme logic simulator is used. Note that the logic function verifying unit 26 and the operation verifying unit 34 are provided from the microcell library 24 with information about a primitive, which is a circuit element's minimum unit, such as an inverter, buffer, OR gate, AND gate, EOR gate, or dot gate.

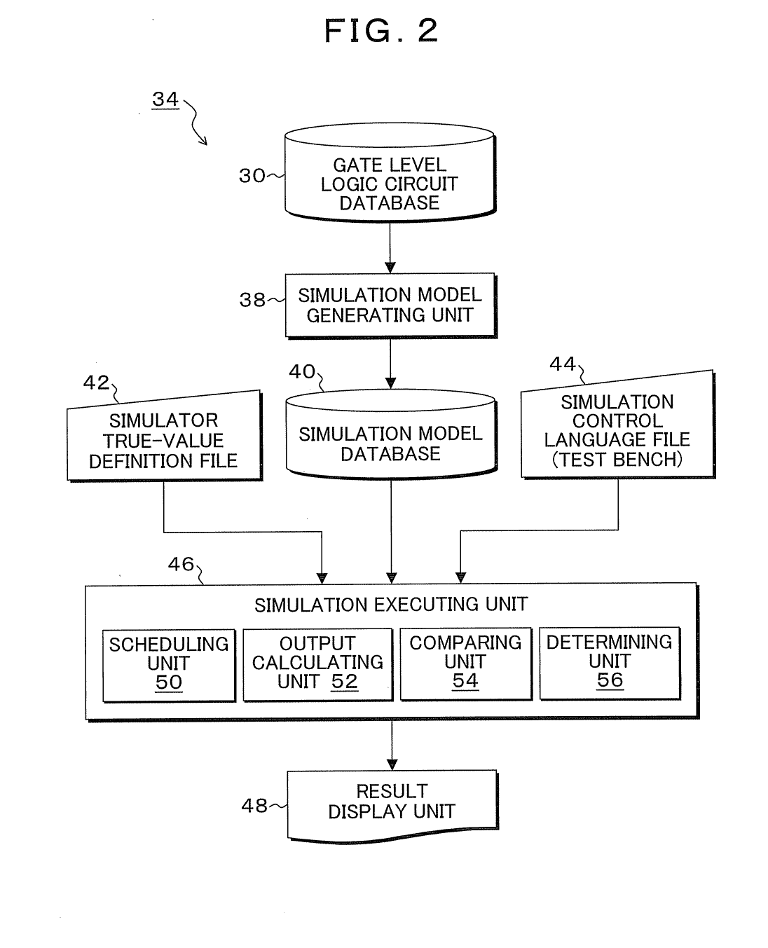

FIG. 2 is an illustrative diagram depicting details of the operation verifying unit 34 using an event-driven-scheme logic simulator of the present embodiment provided to the logic designing unit 14 of FIG. 1. The operation verifying unit 34 of FIG. 2 includes the gate level logic circuit database 30, a simulation model generating unit 38, a simulation model database 40, a simulator true-value definition file 42, a simulation control language file 44, a simulation executing unit 46, and a result display unit 48. The simulation model generating unit 38 retrieves from the gate level logic circuit database 30 logic information required for simulation, which is converted by the simulation executing unit 46 to an executable simulation model at a primitive level (basic gate) and is stored in the simulation model database 40. Subsequently, the simulation executing unit 46 executes a simulation by using a simulation control language stored in the simulation control language file 44 and a simulator definition file stored in the simulator true-value definition file 42 expanded by the present embodiment, the simulation control language describing a description of a test pattern input to a target simulation circuit of the simulation model database 40, a simulation processing procedure, check and others. The execution result of the simulation executing unit 46 is output and displayed on the result display unit 48, and the execution result can be checked. In the simulator true-value definition file 42, in addition to normal quarternary-value states, that is, 0, 1, Z (high impedance), and X (undefined value), true-value tables of basic gates serving as primitives, that is, true-value tables for a buffer, inverter, AND gate, OR gate, EOR gate, and dot gate, are stored, the true-value tables using septenary-value states including a first logical value A, a second logical value B, and a third logical value K as special states newly added in the present embodiment.

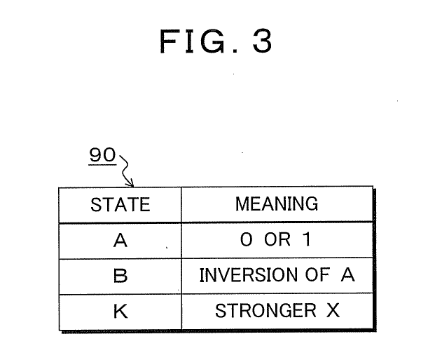

FIG. 3 is an illustrative diagram depicting definitions of the added special states in the present embodiment. In FIG. 3, an added special state definition file 90 of the present embodiment has set therein the first logical value A, the second logical value B, and the third logical value K as special states. The first logical value A is a logical value representing 0 or 1. On the other hand, the second logical value B represents 1 or 0 as an inverted value corresponding to the first logical value A. Furthermore, the third logical value K is defined as an undefined value X stronger than a normal undefined value X. Note in the following description that the first logical value A, the second logical value B, and the third logical value K are described as special states A, B, and K. With reference to FIG. 2 again, the simulation executing unit 46 uses true-value tables of primitives (basic gates) using septenary-value states, that is, the special states A, B, and K of the present embodiment added as in FIG. 3 to the normal quarternary-value states 0, 1, Z, and X defined in the simulator true-value definition file 42 to verify the operation of a logic circuit model in the simulation model database 40 as a target. Therefore, a scheduling unit 50 provided to the simulation executing unit 46 schedules, for the logic circuit model as a verification target, execution of a simulation with a test pattern including the special state A representing 0 or 1 and the special state B representing 1 or 0 as an inverted value corresponding to the special state A. An output calculating unit 52 performs a logic operation on the logic circuit model obtained from the simulation model database 40 based on the test pattern to calculate an output of the logic circuit model. A comparing unit 54 compares the logic circuit model and an expected value with respect to the test pattern. Furthermore, when the output of the logic circuit model and the expected value are equal to each other, a determining unit 56 determines that the operation of the logic circuit model as a target is correct, and causes the determination result to be output and displayed on the result display unit 48.

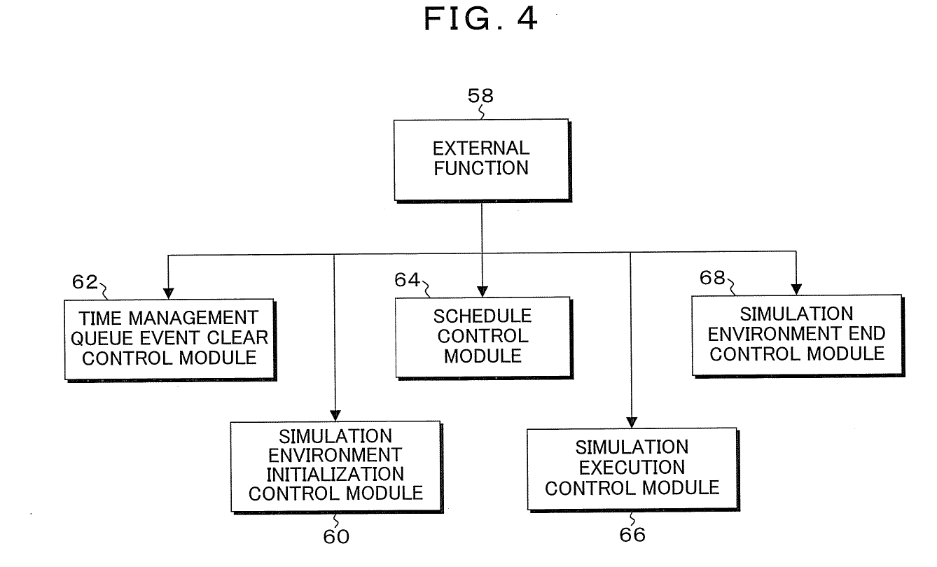

FIG. 4 is an illustrative diagram depicting a program structure of the simulation executing unit 46 provided to the operation verifying unit 34 of FIG. 2. In the event-driven-scheme simulation execution programs of FIG. 4, as programs called by an external function 58, a simulation environment initialization control module 60, a time management queue event clear control module 62, a schedule control module 64, a simulation execution control module 66, and a simulation environment end control module 68 are provided. In the simulation execution programs having this program-module structure are known as being of an event-driven scheme. In the event-driven-scheme simulation execution programs, attention is given to a base gate (primitive), such as a logic gate with an event causing a change of a signal, only the element at the next stage of an element where an event has occurred is subjected to an operation based on the true-value tables and, when the output from the element is changed, the change of the signal is sequentially transferred to the next stage to verify whether the set expected value can be obtained by the element as a target.

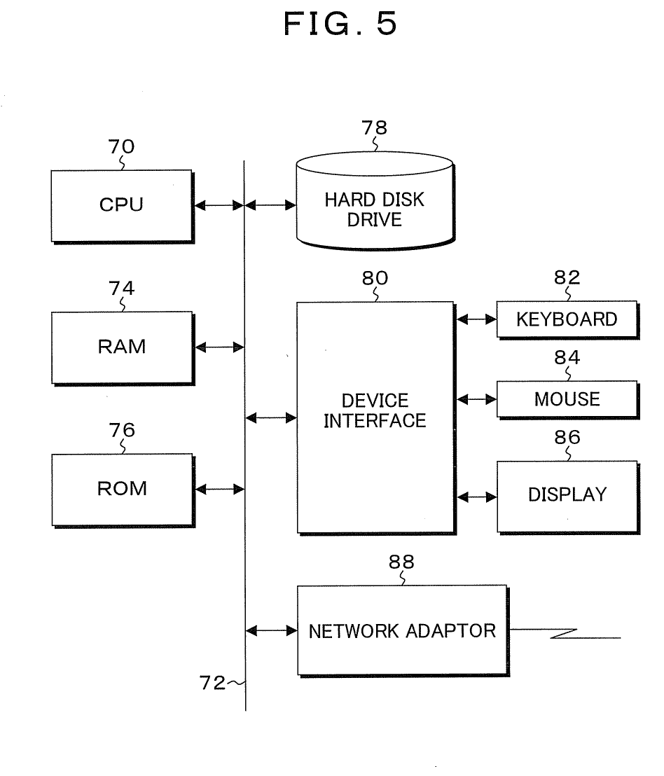

FIG. 5 is a block diagram depicting a hardware environment of a computer on which a program of the present embodiment is executed. In FIG. 5, a RAM 74, a ROM 76, a hard disk drive 78, a device interface 80 connecting a keyboard 82, a mouse 84, and a display 86, and a network adaptor 88 are connected to a bus 72 of a CPU 70. In the hard disk drive 78, the programs of the present embodiment are stored. When the computer is started, with a boot process of a BIOS system not shown, an OS of the hard disk drive 78 is loaded to the RAM 74 and is executed by the CPU 70 and, when the OS starts, the programs of the present embodiment are read to the RAM 74 from the hard disk drive 78 and are executed by the CPU 70.

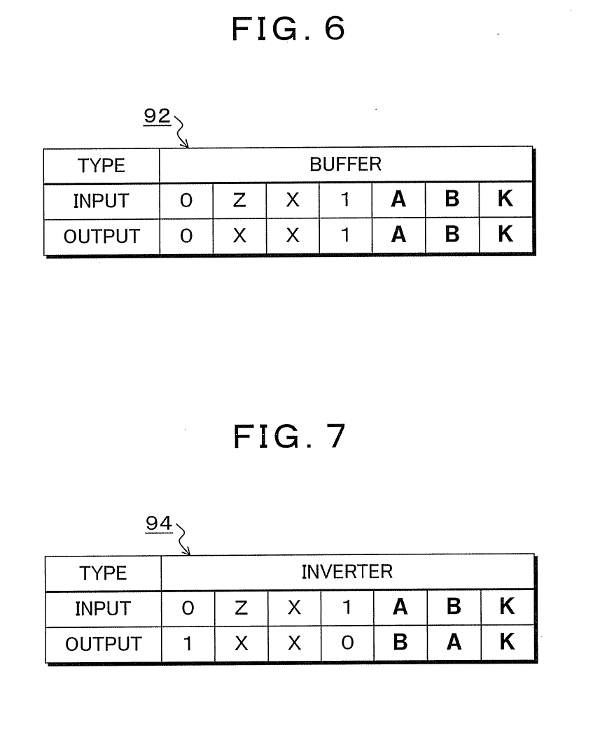

FIG. 6 is an illustrative diagram depicting a buffer true-value table in the present embodiment stored in the simulator true-value definition file 42 of FIG. 2. In FIG. 6, a buffer true-value table 92 has septenary-value states, that is, the special states A, B, and K added in the present embodiment in addition to the normal quarternary-value states 0, Z, X, and 1, as input values, and outputs are in one-to-one correspondence to the respective states.

FIG. 7 is an illustrative diagram depicting an inverter true-value table in the present embodiment. In an inverter true-value table 94 of FIG. 7, inputs include the added special states A, B, and K of the present embodiment in addition to the normal quarternary-value states 0, Z, X, and 1, and outputs have values obtained by inverting the inputs. Among these, the special state A of input has an output of the special state B owing to inversion, the special state B of input also has an output of the special state A owing to inversion, and further the special state K has an output of the same special state K.

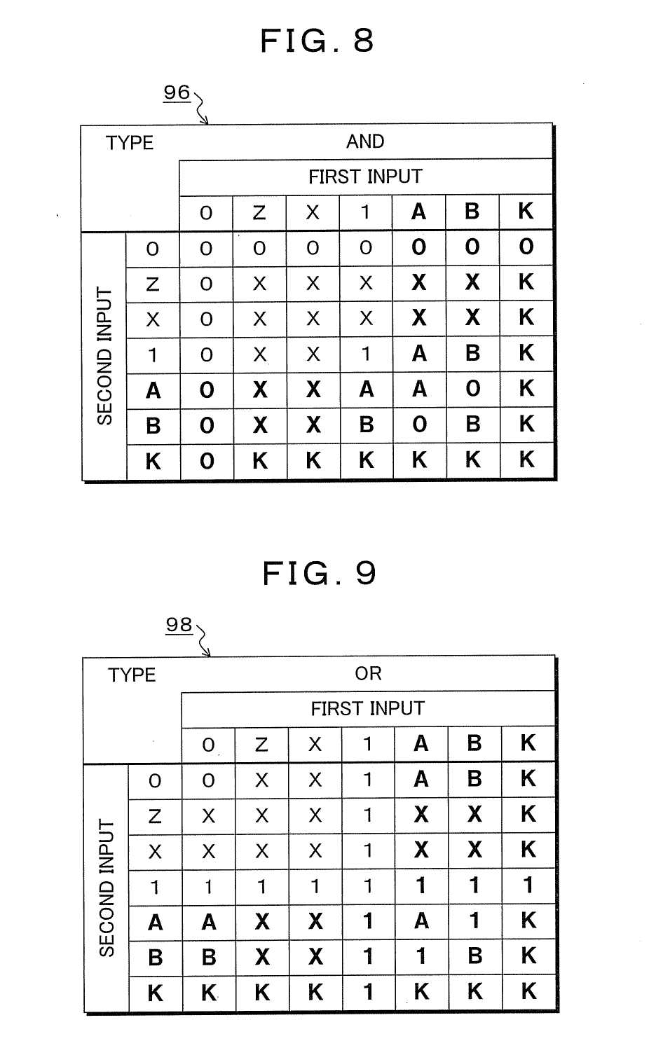

FIG. 8 is an illustrative diagram depicting an AND-gate true-value table in the present embodiment. In FIG. 8, an AND-gate true-value table 96 takes an 2-input 1-output AND gate as an example, and first inputs and second inputs are septenary-value states, that is, the special states A, B, and K of the present embodiment in addition to the normal quarternary-value states 0, Z, X, 1.

Here, in the case where the first input indicates the special state A or B and the second input indicates the quarternary-value state 0, Z, X, or 1, when the first input indicates the special state A, outputs of the second input states 0, Z, X, and 1 indicate the states 0, X, X, and A, which are basically identical to the outputs by a combination of the first inputs and the second inputs of the normal quaternary-value states. By contrast, as for the special state K, the output indicates the state 0 when either one of the first input and the second input indicates the special state K and the other indicates the state 0. That is, (0, K)=(K, 0)=0.

As for other inputs in combination with the special state K, their outputs all indicate the special state K.

FIG. 9 is an illustrative diagram depicting an OR-gate true-value table in the present embodiment. In FIG. 9, for an OR-gate true-value table 98, a 2-input 1-output OR gate is taken as an example. In the OR-gate true-value table 98, when either ones of the first inputs and the second inputs indicate the normal quarternary-value states 0, Z, X, and 1 and the other input indicates the special state A, the output states indicate A, X, X, and 1, which are identical to those of the normal quarternary-value states 0, Z, X, and 1. The same goes for the special state B. By contrast, as for the special state K, the output indicates the state 1 only when either one of the first input and the second input indicates the special state K and the other indicates the state 1. That is,

### (1, K)=(K, 1)=1.

As for other input combinations with the special state K and the normal states 0, Z, X, and 1, their outputs all indicate the special state K.

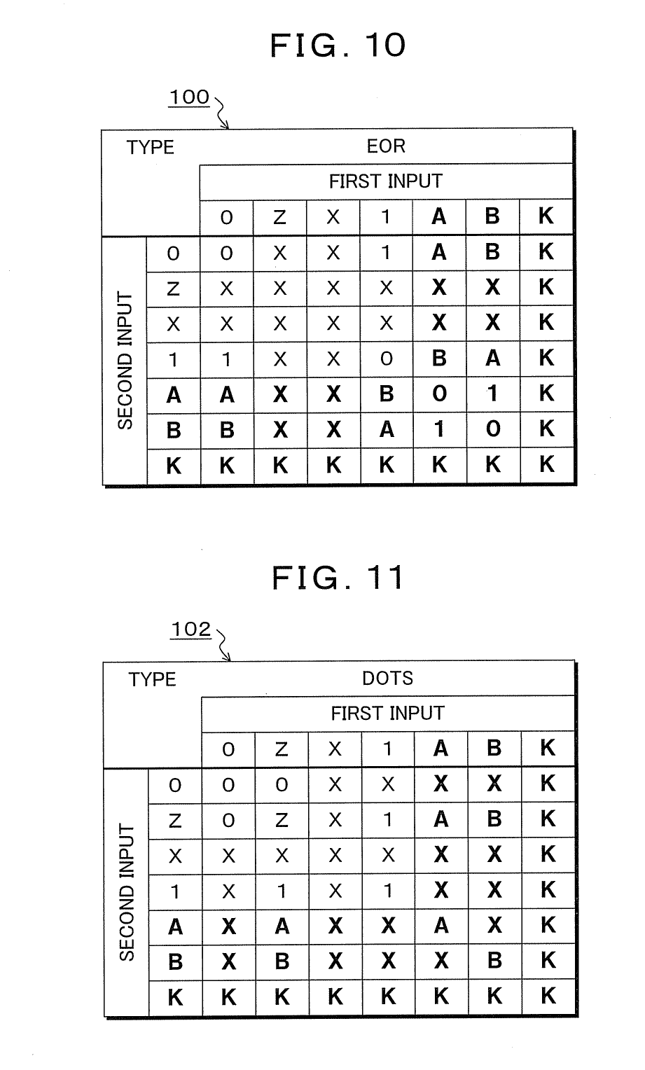

FIG. 10 is an illustrative diagram depicting an EOR-gate (exclusive-OR operation circuit) true-value table in the present embodiment. In FIG. 10, for a true-value table 100 of an EOR gate, a 2-input 1-output EOR gate is taken as an example. In the EOR-gate true-value table 100, as a combination of first inputs and second inputs, when either ones of them indicate the normal quarternary-value states 0, Z, X, and 1 and the other indicates the special state A, the output states indicate A, X, X, and B, which are basically identical to those in the case where either one of input states in the normal quarternary values indicates 0 and the other input state indicates any of 0, Z, X, and 1. The same goes for the special state B. By contrast, as for the special state K, even either one of the first input and the second input indicates the special state K and the other indicates any of the normal quarternary-value states 0, Z, X, and 1 and the special states A and B, the output states all indicate the special state K.

FIG. 11 is an illustrative diagram depicting a true-value table of a dot operation circuit in the present embodiment. In a dot-gate true-value table 102 of FIG. 1, a 2-input 1-output dot gate is taken as an example. In the dot-gate true-value table 102, as for the special states A and B, when either ones of the first inputs and the second inputs indicate the special states A and B and the other indicates any of the normal quarternary-value states 0, Z, X, and 1 and the special states A and B, the output states indicate X, A, X, X, A, and X, which are basically identical to those when one input indicates the state 0 or 1 and the other inputs indicate the state 0, Z, X, 1, A, and B. By contrast, as for the special state K, for all cases where either one of the first input and the second input indicates the special state K and the others indicate the quarternary-value states 0, Z, X, and 1 and the special states A, B, and K, their outputs indicate the special state K. Next, as operation verification of the logic circuit model of the present embodiment using the true-value tables depicted in FIG. 6 to FIG. 11, a specific example of check and verification of a path activation test is described.

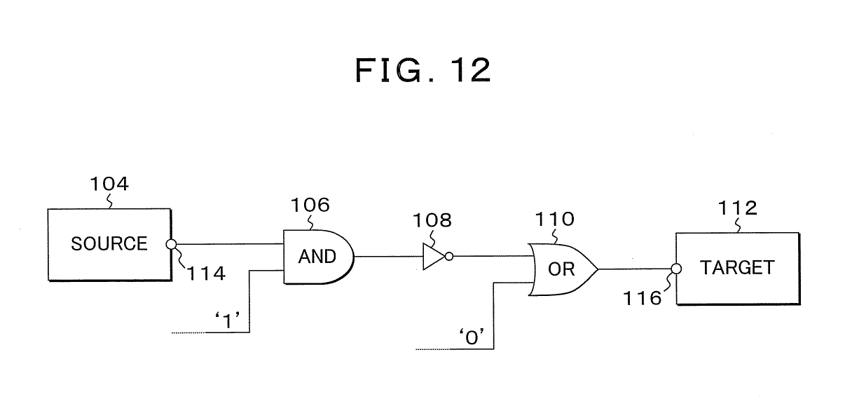

FIG. 12 is a circuit diagram depicting an example of a single path subjected to activation verification. In this single path, a pin 114 of a source 104 is next connected to an AND gate 106, this AND gate 106 is connected to an OR gate 110 via an inverter 108, and an output from the OR gate 110 is connected to a pin 116 of a target 112.

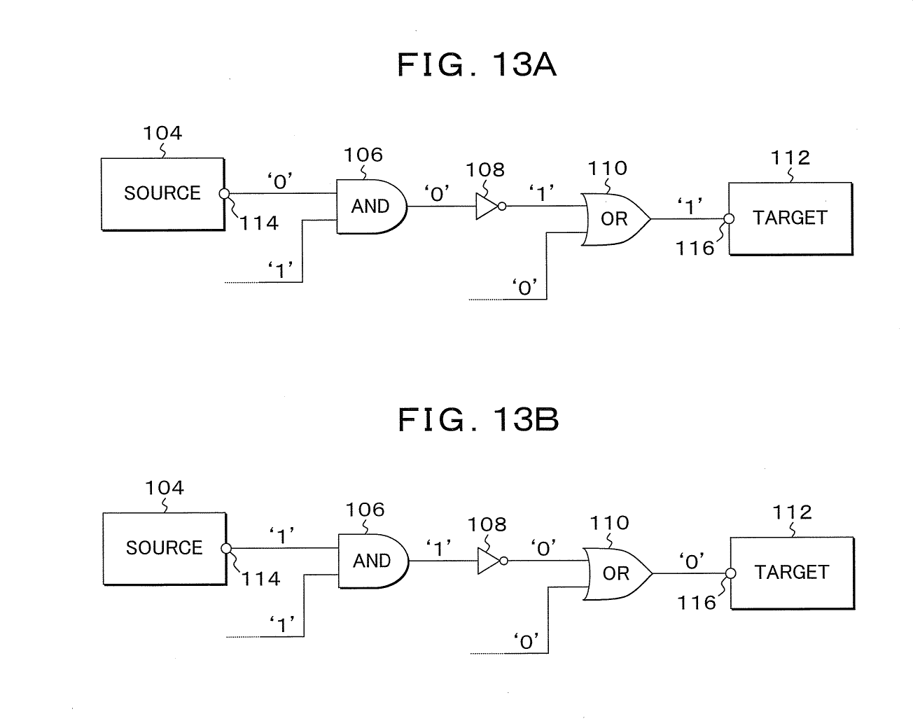

FIGS. 13A and 13B are circuit diagrams depicting conventional activation verification of a single path of FIG. 12 using the normal quarternary-value states. For the single path of FIG. 12, it is assumed that

“Is activation made with a reversed polarity from the output pin 114 of the source 104 to the input pin 116 of the target 112?”
is set as an activation verification item. For this activation verification item of a single path, in activation verification using the conventional quarternary-value states 0, Z, X, and 1, first as in FIG. 13A, the state 0 is set in the output pin 114 of the source 104 serving as a driver, and a simulation is executed by using a true-value table having the quarternary-value states 0, Z, X, and 1. In this case, the state 1 propagates to the input pin 116 of the target 112 serving as a receiver, thereby satisfying the activation verification item. Subsequently, as depicted in FIG. 13B, the state 1 is set in the output pin 114 of the source 104 to execute a simulation. In this case, the state 0 propagates to the input pin 116 of the target 112 serving as a receiver, thereby satisfying the activation verification item. In this manner, in activation verification of a single path using the conventional quarternary-value states 0, Z, X, and 1, the states 0 and 1 are required to be set in the output pin of the source serving as a driver to execute simulations, and therefore two simulations are required. Note that although the logic between the source 104 and the target 112 is simple in the example of FIGS. 13A and 13B, when the logic is complex, it is an extremely difficult operation to check whether the value set in the output pin 114 of the source 104 has really propagated to the input pin 116 of the target 112 serving as a receiver.

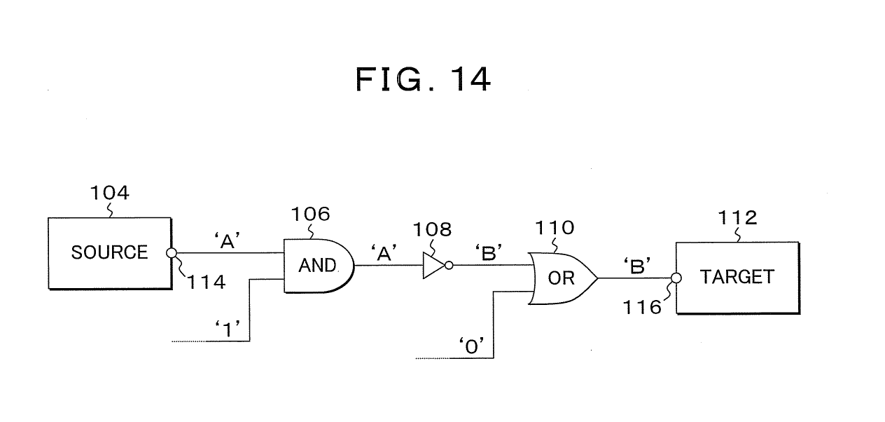

FIG. 14 is a circuit diagram depicting activation verification of a single path using the special states A and B added in the present embodiment. In FIG. 14, for example, the special state A is set in the output pin 114 of the source 104 serving as a driver to execute a simulation, thereby making activation check possible with the special state B, which indicates an inverted value of the special state A, having arrived at the input pin 116 of the target 112. Specifically, when the special state A is set in the output pin 114 of the source 104, the next input of the AND gate 106 becomes (A, 1), and the output state in this case becomes the state A from the AND-gate true-value table of FIG. 8. Subsequently, the output is inverted to the state B by the inverter 108. In the next OR gate 110, the input indicates (B, 0), and its output state becomes the special state B according to the OR-gate true-value table 98 of FIG. 9. Therefore, the special state B as an inverted value of the special state A of the output pin 114 of the source 104 serving as a driver arrives at the pin 116 of the target 112 serving as a receiver, thereby checking that the verification item is satisfied. In this manner, in activation verification of a single path using the special state A or B of the present embodiment of FIG. 14, the verification item can be checked with one simulation. Furthermore, checking whether the special state set in the output pin 114 of the source 104 has propagated to the input pin 116 of the target 112 can be done by checking that the special state B, which is an inverted value of the special state A, has propagated, thereby allowing an easy and simple check.

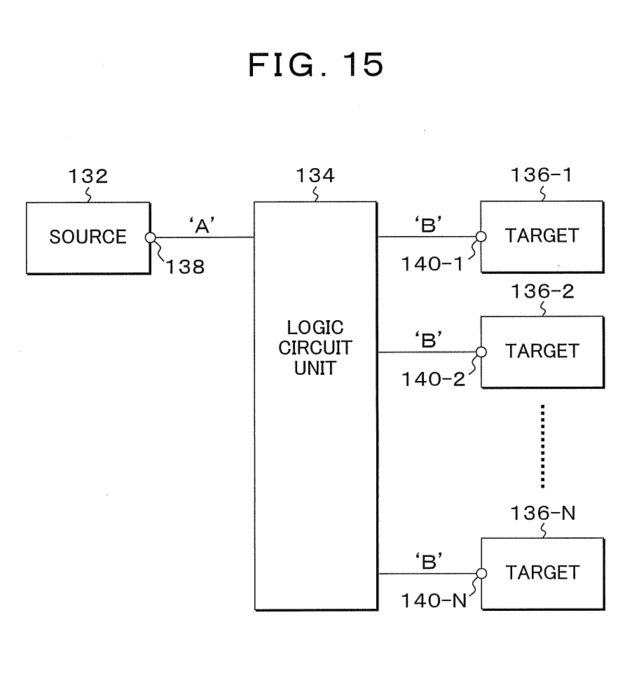

FIG. 15 is a circuit diagram depicting activation verification of a plurality of paths using the special states A and B of the present embodiment. In the plurality of paths of FIG. 15, there are a plurality of one-to-N paths from an output pin 138 of a source 132 serving as a driver via an appropriate logic circuit unit 134 to input pins 140-1 to 140-N of N targets 136-1 to 136-N. It is assumed herein that

“Is activation made with a reversed polarity from the output pin 138 of the source 132 to all input pins 140-1 to 140-N of the targets 136-1 to 136-N?”
is set as an activation verification item to the plurality of one-to-N paths of FIG. 15. For this activation verification item of the plurality of paths, when the special state A is set in the output pin 138 of the source 132 serving as a driver to execute a simulation in the present embodiment, the special state B, which is an inverted value of the special state A, has arrived at all input pins 140-1 to 140-N of the targets 136-1 to 136-N, thereby easily checking that the activation verification item to the plurality of one-to-N paths is satisfied. Note that in activation verification for the plurality of one-to-N paths of FIG. 15, the special state B may be set in the output pin 138 of the source 132 serving as a driver to execute a simulation and it may be checked that the special state A, which is an inverted value of the special state B, has arrived at all input pins 140-1 to 140-N of the targets 136-1 to 136-N.

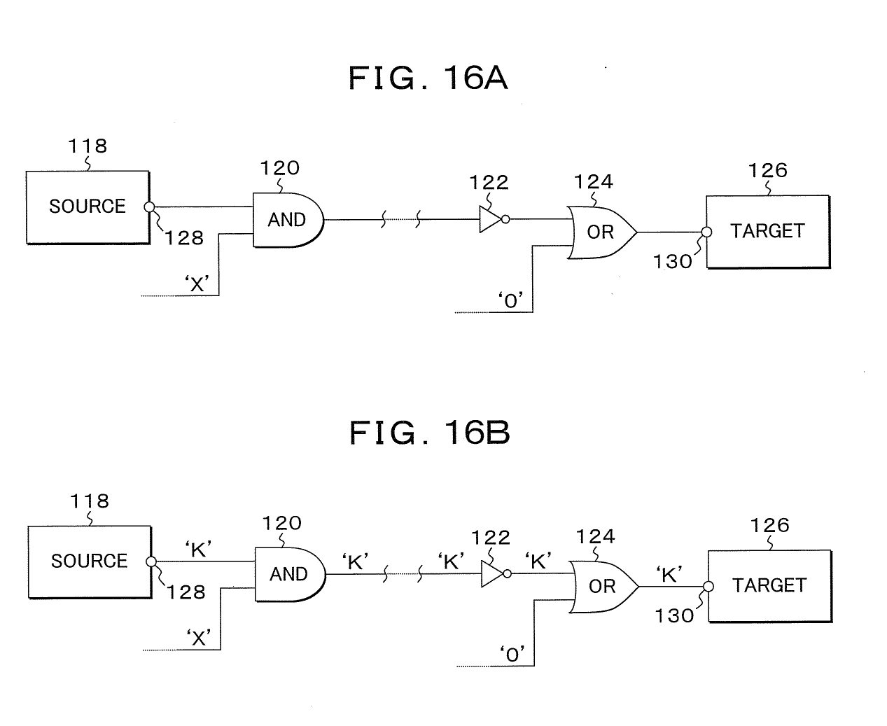

FIGS. 16A and 16B are circuit diagrams depicting path through check and verification using the special state K of the present embodiment. FIG. 16A depicts an example of a path as a target for through check and verification, in which the path is input from an output pin 128 of a source 118 to an AND gate 120, is input from an inverter 122 to an OR gate 124 via a logic circuit omitted midway, and is connected from the OR gate 124 to an input pin 130 of a target 126 serving as a receiver. For this path, as a through check and verification item, it is assumed that

“Does the input pin 130 of the target 126 take the output pin 128 of the source 118 as a driver?”
is set. For this through check and verification item, with the normal quarternary-value state 0, Z, X, 1, even when the value set in the output pin 128 of the source 118 is changed midway or the value set in the output pin 128 of the source 118 arrives at the input pin 130 of the target 126, it is extremely difficult to check whether the value has really propagated from the output pin 128 of the source 118.

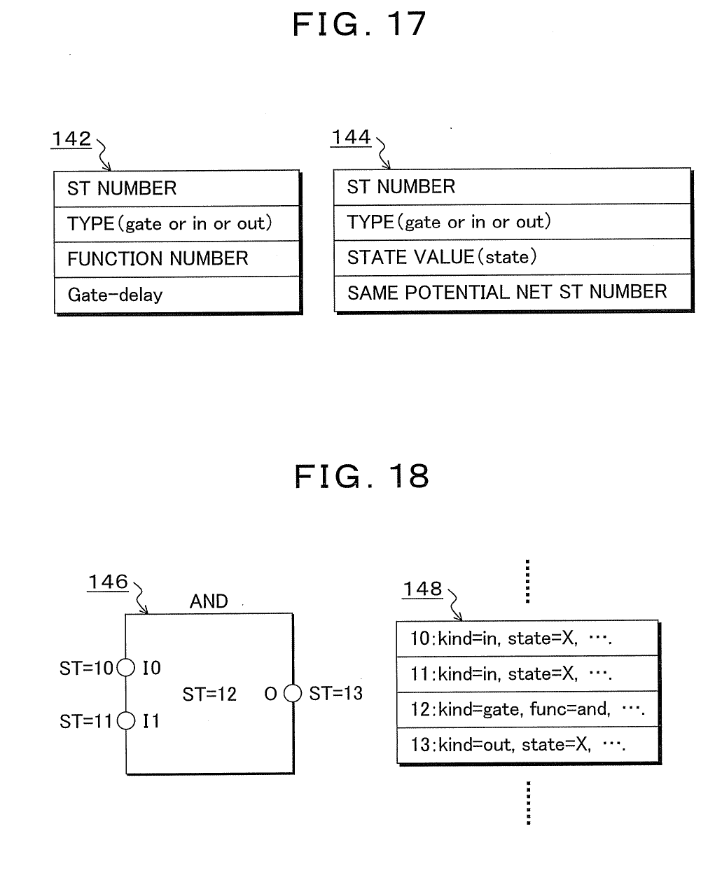

FIG. 16B depicts through check and verification using the special state K of the present embodiment. In this case, the special state K is set in the output pin 128 of the source 118 to execute a simulation based on the true-value tables with the ternary-value special states in addition to the normal quarternary-value states depicted in FIG. 6 to FIG. 11. Specifically, when the special state K is set in the output pin 128 of the source 118, the input of the AND gate 120 becomes (K, X), and its output indicates the special state K according to the AND-gate true-value table 96 of FIG. 8. Furthermore, the special state K propagates via the logic circuit unit omitted midway, the input of the inverter 122 becomes K, K also propagates to its output and, finally, the input of the OR gate 124 becomes (K, 0) and its output becomes the special state K according to the OR-gate true-value table of FIG. 9, meaning that the special state K propagates to the input pin 130 of the target 126. In this manner, the special state K in the present embodiment is set in the output pin 128 of the source 118 to execute a simulation based on the true-value tables with septenary-value states having three special states A, B, and K added in the present invention to the normal quarternary-value states and check that the special state K has arrived at the input pin 130 of the target 126, thereby allowing an easy and simple through check and verification of a path. Next, a process operation of an event-driven-scheme logic simulator, which is a specific embodiment of the operation verifying unit 34 depicted in FIG. 2, is described. In the event-driven-scheme logic simulator functioning as the operation verifying unit 34 of the present embodiment, simulation tables with a data structure as depicted in FIG. 17 are generated for data of simulation models as verification targets.

In FIG. 17, specifically, as simulation models, a station table 142 of the gate itself and a station table 144 for respective input and output pins of the gate are generated. The station table 142 of the gate itself has registered therein a station table number (hereinafter referred to as “ST number”), type of gate input or output, function number, and gate delay. The station table 144 regarding the input and output pints of the gate has registered therein an ST number, type of gate input or output, state value, and same potential net ST number.

FIG. 18 is an illustrative diagram depicting a simulation table of a 2-input 1-output AND gate. In FIG. 18, an AND gate 146 has a first input pin I0, a second input pin I1, and an output O, and their ST numbers are ST=10, 11, and 13. Also, the ST number of the gate itself is ST=12. On the right side of the AND gate 146, a station table 148 is depicted for the gate itself and the input and output pins. In the station table 148, the first and second lines represent details of the first input pin 10 and the second input pin I1 with ST=10 and 11, respectively, the third line represents details of ST12 of the AND gate 146 itself, and further the fourth line represents details of the output O with ST=13. In the event-driven-scheme logic simulator of the present embodiment, a process is performed in two steps of;

(1) scheduling a simulation value; and

(2) executing a simulation.

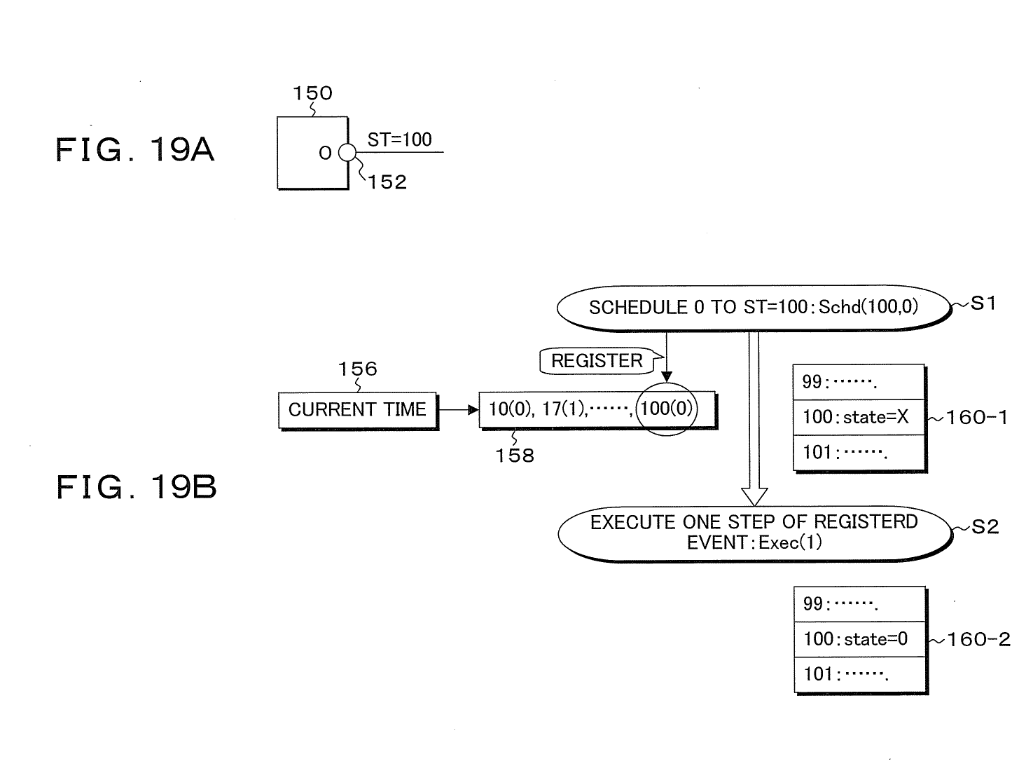

FIGS. 19A and 19B depict general outlines of control in the event-driven-scheme logic simulator. FIG. 19A depicts an example of a schedule target 150, and ST=100 is set in an output pin 152 as an ST number. For this scheduling target, a schedule-function function is executed at step 51 of FIG. 19B and, subsequently, a simulation-execution-function function is executed at step S2. The schedule-function function at step S1 is an event registration function and, for example, when it is assumed as a schedule-function function that

“0 is scheduled to ST=100: Schd(100, 0)”,

the current time of a time management table 156 for managing the number of execution stags is registered in an event table 158. Details to be registered in the event table 158 include two items, that is, the ST number, ST=100, and the schedule value of 0 given by the schedule-function function. At the time of scheduling at this step S1, the schedule value of 0 is not reflected to the state value of ST=100 in a station table 160-1, and the state value still remains the state X as before. Subsequently, the simulation-execution-function function is processed at step S2. In this process of the simulation-execution-function function, an event registered in the event table 158 is processed for the time management table 156 of one stage given by the process of the schedule-function function at step S1. That is, the simulation-execution-function function at step S2 is a process of

“execute one step of the registered event: Exec(1)”

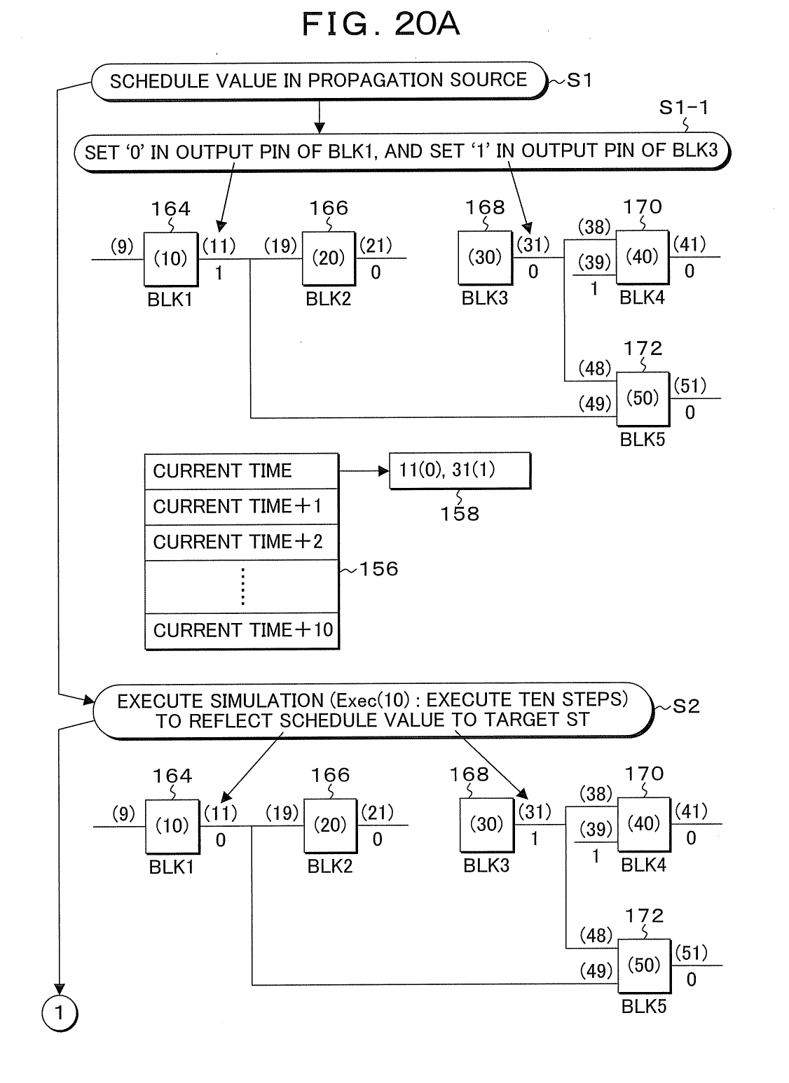

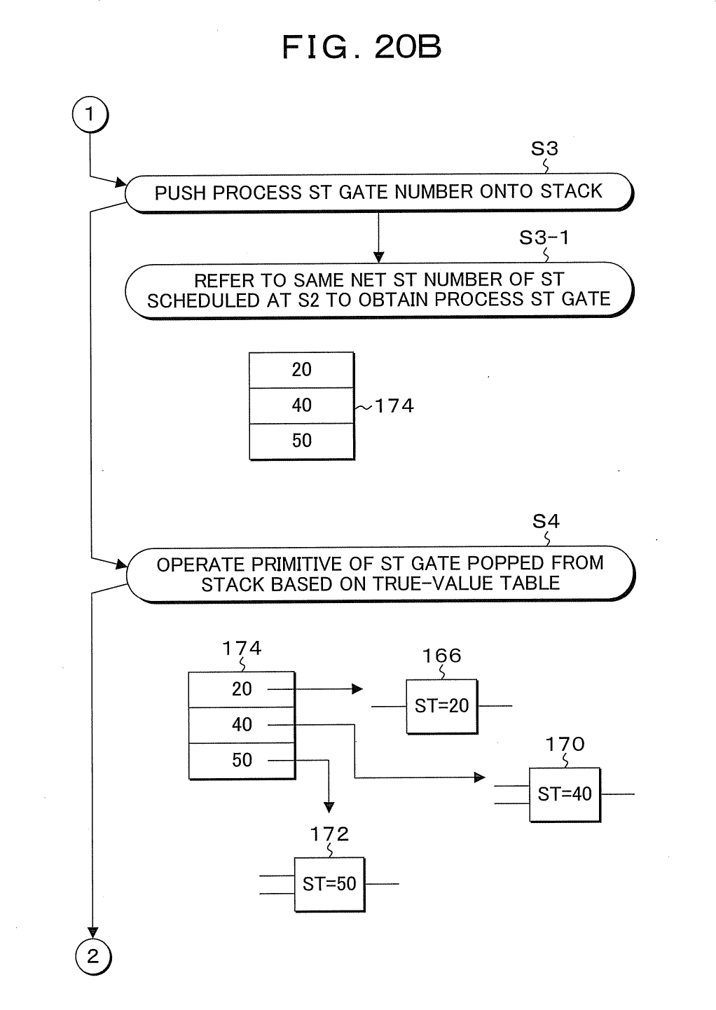

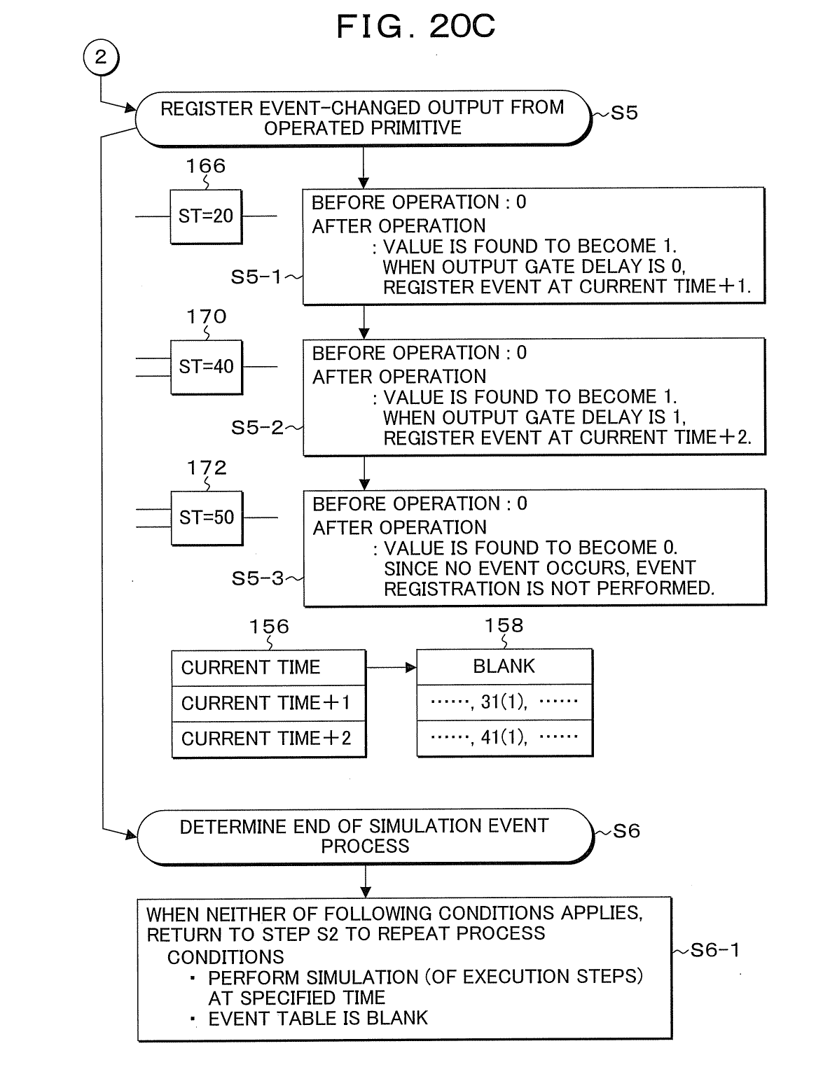

and, with this execution of one step of the registered event, the scheduled value of “0” is reflected to the state value of ST=100 as depicted in a station table 160-2. These process of the schedule-function function at step S1 and subsequent process of the simulation-execution-function function at step S2 end when the processes reach a specified number of stages of the time management table 156 or no more event is to be processed. Next, with reference to FIG. 20A and FIG. 20B, a process operation by an event-driven-scheme logic simulation of the present embodiment is specifically described. At step S1 of FIG. 20A, a value is scheduled in a propagation source for a logic circuit model including buffers 164 and 168, an inverter 166, and AND gates 170 and 172 shown below. Specifically, as depicted at step S1-1, a value of 0 is set in an output pin of BLK1 as the buffer 164, which is a propagation source, and a value of 1 is set in an output pin of BLK3 as the buffer 168. With this scheduling process, the event table 158 is registered at the current time of the time management table 156 having 10 execution stages, and the registration details of the event table 158 indicate “11(0), 31(1)” by a combination of the ST number and the schedule value. Subsequently at step S2, a simulation is performed for ten stages as to the time management table 156 to reflect the schedule value to the target station table(s). In this case, the number of target station tables is two, that is, ST=11 of the output pin of the buffer 164 and ST=31 of the output pin of the buffer 168. The schedule value of 0 set at S1-1 is reflected to ST=11 and the schedule value of 1 is reflected to ST=31. Next at step S3 of FIG. 20B, the gate number of the station table to be processed is pushed to a stack 174. Specifically, as depicted at step S3-1, with reference to the same net ST numbers of the station table scheduled at step S2 of FIG. 20A, as process ST gates, ST=20 of the inverter 166, ST=40 of the AND gate 170, and ST=50 of the AND gate 172 are obtained, and ST=20, 40, and 50 are pushed as depicted at the stack 174 for registration. Subsequently at step S4, a simulation is operated for primitives of the gate of the station table popped from the stack 174 based on the true-value tables. That is, the inverter 166 is specified from ST=20 in the stack 174, the operation is performed based on the inverter true-value table 94 of FIG. 7. Also, the AND gate 170 is specified from ST=40 in the stack 174, the AND gate 172 is specified from ST=50, and the operation is performed based on the AND-gate true-value table 96 depicted in FIG. 8. Subsequently, the procedure goes to step S5 of FIG. 20C, an event-changed output from a primitive operated at step S4 of FIG. 20B is registered in the event table 158. In this case, as depicted at step S5-1, step S5-2, and step S5-3, the operation results are obtained for the inverter 166 and the AND gates 170 and 172. For the inverter 166 and the AND 170 at steps S5-1 and 5-2, since the value before operation is changed after operation, an event change is determined. On the condition of a delay of the output gate, an ST number of ST=31 and a value of 1 after operation are registered in the event table 158 for the AND gate 170, and an ST number=41 of the AND gate 170 and a value of 1 after operation are registered on the third line of the event table 158. Subsequently at step S6, a determination of the end of the simulation event process is made. As depicted at step S6-1, this process determination takes, as determination end conditions:

(1) perform a simulation (of execution stages) at a specified time; and

(2) the event table is blank,

and when neither of them applies, the procedure returns to step S2 of FIG. 20A to repeat the process. When both apply, the simulation process ends.

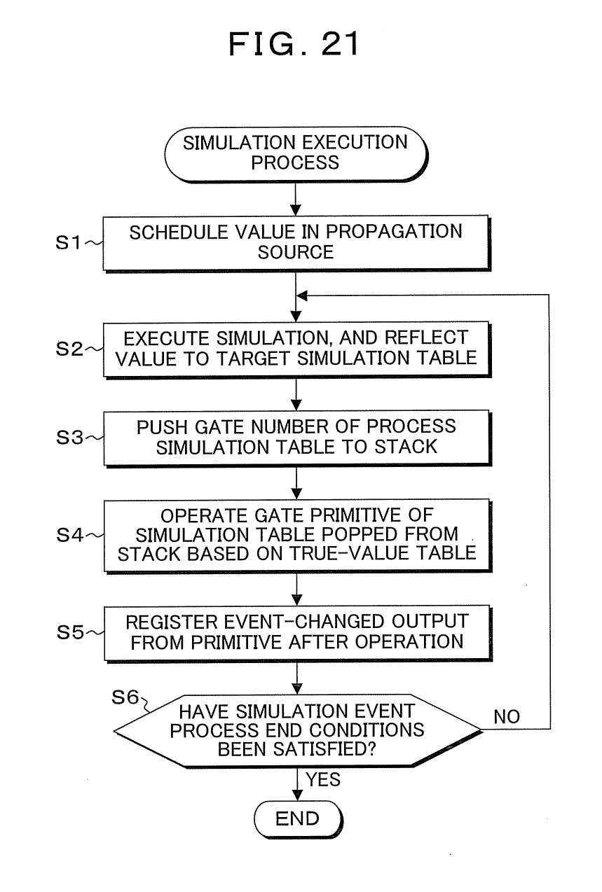

FIG. 21 is a flowchart collectively depicting the process procedures of the event-driven-scheme simulation processes of FIG. 20A to FIG. 20C. In FIG. 21, in a simulation process, after a value is scheduled in a propagation source at step 51, a simulation is executed at step S2 to reflect a value to the target simulation table. Subsequently, after the gate number of the process simulation table is pushed to the stack at step S3, an operation is made at step S4 based on true-value table of gate primitives in the simulation table popped from the stack. Subsequently, an event-changed output from an operated primitive is registered in the event table at step S5. Subsequently at step S6, unless the simulation event end conditions, that is, execution of a simulation at a specified number of stages to be executed or time and a blank in the event table, are satisfied, the procedure returns to step S2 to repeat a similar process. Upon determination of the process end conditions at step S6, a series of processes end. The present invention also provides a program executed on a hardware environment of the computer depicted in FIG. 5, and this program includes details of the processes of the flowcharts depicted in FIG. 20A to FIG. 21. At the same time, the flowcharts depicted in FIG. 20A to FIG. 21 also depict a procedure of a logic circuit model verifying method in the present embodiment. Here, as the simulation result of an event-driven-scheme logic simulation using true-value tables of primitives with septenary-value states including ternary-value special states A, B, and K in addition to the normal quarternary-value states 0, Z, X, and 1 of the present embodiment, the following results are obtained.

Target LSI:

UNIX (R) server processor (SPARC64-V)

Verification Details:

LSI scan circuit design rule (scan control verification complying with JTAG specifications)

Simulation Result:

Verification time is reduced 2.5 times as before (reduced by 65%), and verification efficiency is reduced by 18% as before in controllability (amount of control language description). Note that as a logic simulation of a logic circuit model, an event-driven-scheme is taken as an example in the present embodiment, but the present invention is not meant to be restricted by this and, as a matter of course, an appropriate logic simulation may be used as long as it is a logic simulation using true-value tables of primitives with septenary-value states including three special states A, B, and K in addition to the normal quarternary-value states 0, Z, X, and 1. Also, in the above embodiment, true-value tables of primitives with septenary-value states including three added special states A and B and also special state K are used. Alternatively, only activation verification of a path may be performed by using true-value table with the special states A and B added to the normal quarternary-value states 0, Z, X, and 1, or only through check and verification of a path may be performed by using true-value tables with quinary-value states with the special state K of the present embodiment added to the normal quarternary-value states 0, Z, X, and 1. Also, the present invention includes appropriate modifications that do not impair its objects and advantages and, furthermore, is not restricted by the numerical values shown in the above embodiments.

What is claimed is:

1. A verifying method for verifying an operation of the logic circuit model, by giving a test pattern in which predetermined logical values are combined to an input of a logic circuit model and comparing an output of the logic circuit model and an expected value for the test pattern, the method comprising:
giving the logic circuit model a test pattern in which a first logical value representing one of 0 or 1 and a second logical value representing the other of 1 or 0 are combined;
performing a logic operation based on the test pattern given to the logic circuit model;
comparing the output of the logic circuit model that has performed the logic operation and an expected value for the test pattern; and
determining, when the output of the logic circuit model and the expected value are equal to each other, that the operation of the logic circuit model is correct.

2. The verifying method according to claim 1, wherein
the logic operation of the logic circuit model is performed with the second logical value representing 1 when the first logical value represents 0, and the second logical value representing 0 when the first logical value represents 1.

3. The verifying method according to claim 1, wherein
the combination of the predetermined logical values is a combination of any of 0, 1, a first undefined value, or a high impedance.

4. The verifying method according to claim 1, the test pattern further includes a third logical value representing a second undefined value different from the first undefined value,
when a logical value of one input of a logical multiplication operation circuit represents 0, and when the third logical value is input as a logical value of another input of the logical multiplication operation circuit, the logical multiplication operation circuit outputs 0, and
when a logical value of one input in the logical multiplication operation circuit represents any of 1, the first undefined value, and the high impedance and, when the third logical value is input as a logical value of another input of the logical multiplication operation circuit, the logical multiplication operation circuit outputs the third logical value.

5. The verifying method according to claim 1, wherein
the test pattern further includes a third logical value representing a second undefined value different from the first undefined value,
when a logical value of one input in a logical sum operation circuit represents 1, and when the third logical value is input as a logical value of another input of the logical sum operation circuit, the logical sum operation circuit outputs 1, and
when a logical value of one input in the logical sum operation circuit represents any of 0, the first undefined value, and the high impedance, and when the third logical value is input as a logical value of another input of the logical sum operation circuit, the logical sum operation circuit outputs the third logical value.

6. The verifying method according to claim 1, wherein
the test pattern further includes a third logical value representing a second undefined value different from the first undefined value,
when a logical value of one input in an exclusive OR operation circuit represents any of 0, 1, the first undefined value, and the high impedance, and when the third logical value is input as a logical value of another input of the exclusive OR operation circuit, the exclusive OR operation circuit outputs the third logical value.

7. The verifying method according to claim 1, wherein
the test pattern further includes a third logical value representing a second undefined value different from the first undefined value,
when a dot operation of operating a logical value of combined two outputs,
when one of the outputs represents any of 0, 1, the first undefined value, and the high impedance, and when the third logical value is taken as a logical value of another one of the outputs, the third logical value is output.

8. An operation verifying apparatus for verifying an operation of a logic circuit model by using a test pattern which is a combination of predetermined logical values, the apparatus comprising:
a scheduling unit that gives the logic circuit model a test pattern which is a combination of a first logical value a second logical value representing which is a inverted value of the first logical value;
an output calculating unit that performs a logic operation of the logic circuit model based on the given test pattern, and calculates an output value of the logic circuit model;
a comparing unit that compares the output value of the logic circuit model and an expected value which is a value that the logic circuit model is expected to output when the logic operation based on the given test pattern is performed; and
a determining unit that determines, when the output value of the logic circuit model and the expected value are equal to each other, that the operation of the logic circuit model is correct.

9. The operation verifying apparatus according to claim 8, wherein
when calculating the output value, the output calculating unit assumes the second logical value represents 1 when the first logical value represents 0, and the second logical value represents 0 when the first logical value represents 1.

10. The operation verifying apparatus according to claim 8, wherein
the combination of the predetermined logical values is a combination of any of 0, 1, a first undefined value, or a high impedance.

11. The operation verifying apparatus according to claim 8, wherein
the predetermined logical values include a third logical value representing a second undefined value different from the first undefined value, and
when a logical value of one input in a logical multiplication operation circuit represents 0, and when the third logical value is input as a logical value of another input of the logical multiplication operation circuit, the logical multiplication operation circuit outputs 0, and
when a logical value of one input in the logical multiplication operation circuit represents any of 1, the first undefined value, and the high impedance, and when the third logical value is input as a logical value of another input of the logical multiplication operation circuit, the logical multiplication operation circuit outputs the third logical value.

12. The operation verifying apparatus according to claim 8, wherein
the predetermined logical values include a third logical value representing a second undefined value different from the first undefined value, and
when a logical value of one input in a logical sum operation circuit represents 1, and when the third logical value is input as a logical value of another input of the logical sum operation circuit, the logical sum operation circuit outputs 1, and
when a logical value of one input in the logical sum operation circuit represents any of 0, the first undefined value, and the high impedance, and when the third logical value is input as a logical value of another input of the logical sum operation circuit, the logical sum operation circuit outputs the third logical value.

13. The operation verifying apparatus according to claim 8, wherein
the predetermined logical values include a third logical value representing a second undefined value different from the first undefined value, and
when a logical value of one input in an exclusive OR operation circuit represents any of 0, 1, the first undefined value, and the high impedance, and when the third logical value is input as a logical value of another input of the exclusive OR operation circuit, the exclusive OR operation circuit outputs the third logical value.

14. The operation verifying apparatus according to claim 8, wherein
the predetermined logical values include a third logical value representing a second undefined value different from the first undefined value, and
when operating a dot operation, the third logical value is output when one of the outputs represents any of 0, 1, the first undefined value, and the high impedance, and when the third logical value is taken as a logical value of another one of the outputs.
